(19) United States
(12) Patent Application Publication
(10) Pub. No.: US 2024/0099321 A1
(43) Pub. Date: Mar. 28, 2024

(54) COMPOSITIONS OF MILK AND ENZYMES FOR ADULT NUTRITION

(71) Applicant: ATR Thrive LLC, St. Louis, MO (US)

(72) Inventor: Neville McNaughton, St. Louis, MO (US)

(21) Appl. No.: 18/272,925

(22) PCT Filed: Jan. 19, 2022
(86) PCT No.: PCT/US2022/070251

§ 371 Date: Jul. 18, 2023

Related U.S. Application Data
(60) Provisional application No. 63/139,027, filed on Jan. 19, 2021.

(51) Int. Cl. A23C 9/152; A23C 9/156; A23L 33/135

(52) U.S. Cl. CPC A23C 9/1526; A23C 9/156; A23L 33/135

(57) ABSTRACT

This invention provides a liquid nutritional composition comprising fresh whole milk and chymosin and optionally additional ingredients selected from lactase, lipases or esterases, prebiotics, and probiotics or a combination thereof. In an embodiment, a free-flowing dry powder composition of chymosin and optionally additional ingredients selected from lactase, lipases or esterases, prebiotics, and probiotics or a combination thereof is provided, that can be suspended in fresh milk. The inventive composition may allow fresh milk, which many adults have difficulty digesting, to be digested properly without ill effects and be a useful source of protein and saturated fats which are important macronutrients. The inventive compositions may be used by children over the age of 5 years, and for adults.

### FIELD OF THE INVENTION

This disclosure pertains to nutritional compositions for adults based on milk with added enzymes not normally present in the adult human digestive tract to improve the digestion and nutritional absorption of the milk.

### BACKGROUND

The consumption of milk by adult mammals including humans is unnatural and often has a negative effect on the individual to the point of making milk an item they are unable consume. Common problems are digestive discomfort, gas/flatulence, or diarrhea due to the poor digestion of lactose. Yet, as an adult food, dairy products have the potential to be an important source of protein and fat. Several strategies are used by milk companies to ameliorate these issues include the addition of lactase to split the disaccharide into its two component parts, glucose and galactose. Another strategy is to add probiotic bacteria such as Streptococcus thermophilus, a bacteria that produces the enzyme lactase which can cleave the lactose in vivo in the gut, the ideal place to accomplish this.

Other problems of discomfort may be from an allergenic reaction to A1 milk. It is now recognized that there are two closely related genetics variants of β-casein in milk, termed A1 and A2. Cows' milk β-casein contains 209 amino acids. The A1 and A2 variants differ only at position 67, which is histidine in A1 or proline in A2 milk. Due to the way that β-casein interacts with enzymes found in the digestive system, A1 and A2 are processed differently by digestive enzymes, and a seven-amino peptide, beta-casomorphin-7, (BCM-7) can be released by digestion of A1-beta-casein. It is now known that most bovine milk is A1 milk. A genetic test is available to determine whether a cow produces A2 or A1 type protein in its milk. A comprehensive 2009 review found no conclusive harmful effects from BCM-7,¹ but a more recent study suggests that A2 milk avoids inflammatory effects ascribed to A1 milk.²

Another issue with adult consumption of fresh milk is that the suckling action of infants may produce important enzymes when milk is consumed, particularly lingual lipase and pregastric esterase, which are not produced when adults drink milk from a glass. Lingual lipase and pregastric esterase travel with food to the stomach and continue acting to digest fats in the stomach.³ The failure to suckle means that pregastric esterase and lingual lipase are not combined with milk in the mouth, and milk travels to the stomach without enzymes important for digestion of milk. This virtual absence of oral enzyme means the fat in milk that arrives in the stomach (or abomasum in ruminants) will not be treated and acted upon by the correct oral lipase, depriving the body of valuable energy and nutrients from the fat components in milk.

The term “fats” refers primarily to triacylglycerols, also termed triglycerides, or triglyceride esters, which comprise three fatty acids linked to glycerol with ester linkages. Other fats include phospholipids and cholesterol. This invention is concerned with triacylglycerol fats only.

The digestion of triacylglycerol fats requires the action of lipase or esterase enzymes that cleave the ester linkages to form partial glycerides and free fatty acids (FFA's). This is necessary because fats are hydrophobic and are not effectively soluble in the intestine and do not effectively cross the digestive mucosa.⁴ Triacylglycerol fats must be broken down into FFA's to cross the digestive mucosa. Once absorbed in the intestinal mucosa, FFA's are bound to fatty-acid binding protein and reesterified with the aid of acetyl-CoA to triacylglycerols again. 5 The re-formed triacylglycerols are assembled into chylomicrons in the endoplasmic reticulum in the absorptive cells (enterocytes) of the small intestine.⁶ Chylomicrons transport dietary lipids from the intestine to other locations in the body.

Several lipases with varying chemistry play a role in digestion. A principal lipase in more mature mammals is pancreatic lipase. With regards to newborns, lipases are present in milk⁷ and pregastric lipases are formed during suckling.⁸ Bile salts are required for both pancreatic and milk lipase.⁹

This invention is directed in part to various preduodenal lipases, in particular lingual lipase, pregastric lipase, and gastric lipase.¹⁰ Esterases are closely related enzymes that may also be of value in this invention. 11

Lingual lipase is produced in the serous glands in the mouth, which secrete part of the saliva, and is produced as a mammal eats. Lingual lipase has an optimum pH of 2.0-6.5 and is active in the absence of bile salts.¹² Lingual lipase activity continues in the stomach after food is swallowed.¹³ A closely related enzyme is pregastric esterase (PGE), which has similar morphology, sequence, and activity to lingual lipase.¹⁴ PGE is secreted in the glossoepiglotic area. As used herein, lingual lipase and pregastric esterase are essentially synonymous. Both are believed to play an important role in neonates and infant mammals than other lipases, including other preduodenal lipase variants.¹⁵

Lingual lipase and pregastric esterase are distinguished from other lipases, principally pancreatic lipase, that are delivered to the digestive tract after the food passes the duodenum. Biosynthetic (microbial, fungi and plant) sourced lipases may be viable alternatives to mammalian-sourced lingual lipase that may be utilized in some embodiments herein described. The release of lingual lipase into the mouth in infant mammals is normally a direct result of a suckling action. 16

Digestion of proteins in milk may be another challenge for adults. This invention is also directed to combinations containing protease enzymes. Three principal proteases are in the human digestive system, pepsin, chymotrypsin and trypsin. During the process of digestion, these enzymes, each of which is specialized in severing links between particular types of amino acids, collaborate to break down dietary proteins into their components, i.e., peptides and amino acids, which can be readily absorbed by the small intestine.

Casein is the main protein component in milk,¹⁷ but in non-infant animals casein may not be digested properly. Casein in micellar form, the form normally in fresh milk, is normally digested in cattle stomachs with chymosin, an aspartic endopeptidase, EC 3.4.23.4, that is the main component of rennet, an enzymatic product from cow's stomachs used to make cheese.¹⁸ Humans have different enzymatic mechanisms for digesting casein. 19 Presumably the ability to digest casein decreases with age in humans. As mammals age, the enzymes in the stomach transition from those that hydrolyze milk-based proteins into those more focused on other proteins.

Pepsin is an endopeptidase produced in the chief cells of the stomach lining and is one of the main digestive enzymes in the digestive systems of humans and many other animals, where it helps digest the proteins in food. Pepsin is an aspartic protease, using a catalytic aspartate in its active site. The cleavage specificity of pepsin is broad, but some amino acids like tyrosine, phenylalanine and tryptophan increase the probability of cleavage. Pepsin is produced as proenzyme, pepsinogen, by the chief cells in the stomach wall, and upon mixing with the hydrochloric acid of the gastric juice, pepsinogen activates to become pepsin.

This invention is also directed to combinations containing chymosin (also called rennin) is a protease found in rennet. Rennet is used to separate milk into solid curds (for cheesemaking) and liquid whey and is used in the production of most cheeses. It is an aspartic endopeptidase belonging to the MEROPS A1 family (https://www.ebi.ac.uk/merops/index.shtml). It is produced by newborn ruminant animals in the lining of the abomasum to curdle the milk they ingest, allowing a longer residence in the bowels and better absorption. Bovine chymosin is now produced recombinantly because of the demand to make cheese. Rennet is a complex set of enzymes produced in the stomachs of ruminant mammals. In addition to chymosin, rennet contains other enzymes, such as pepsin and a lipase.

Curdling is the breaking up of an emulsion or colloid into large parts of different corn position through the physico-chemical processes of flocculation, creaming, and coalescence. Curdling is used in making cheese and tofu. Flocculation means a process in which colloids come out of suspension in the form of floc or flake, either spontaneously or due to the addition of a clarifying agent. Creaming means the migration of the dispersed phase of an emulsion, under the influence of buoyancy. The particles float upwards or sink, depending on how large they are and their density compared to the continuous phase, and also how viscous or how thixotropic the continuous phase might be. For as long as the particles remain separated, the process is called creaming. A creamed emulsion increases the likelihood of coalescence due to the close proximity of the globules in the cream. Factors that influence the rate of creaming are similar to those involved in the sedimentation rate of suspension particles and are indicated by Stokes Law. Coalescence is the process by which two or more droplets, bubbles or particles merge during contact to form a single daughter droplet, bubble or particle.

Lingual lipase of bovine source, other pregastric lipases, chymosin, are used industrially in the making of cheese.²⁰ This disclosure provides for the combination of lipases and proteolytic enzymes in combinations with unique biologically active components for nutrition and food products for mammals including adult humans.

### SUMMARY OF THE INVENTION

In an embodiment, this invention provides a liquid nutritional composition for humans, comprising fresh whole milk and a quantity of chymosin having about 5 International Milk Clotting Units (IMCU) to 200 IMCU per liter of milk. In an embodiment, the chymosin quantity is 40.625 IMCU/L of milk. The fresh whole milk is A1 or A2 milk.

The inventive composition may also include an ingredient selected from lactase, a mammalian-derived lipase, a prebiotic, and a probiotic or a combination thereof. In an embodiment, the lactase is present in about 1000-20000 U/L (units of disaccharidase activity) of milk. In an embodiment, the lactase is present in about 3125 U per liter of fresh whole milk.

In an embodiment, the composition may include a lipase selected from lingual lipase and pregastric esterase. The lipase may be present in a quantity of 1-100 lipase/esterase forestomach units (LFU)/L, or 2-5 LFU/L, or 3.5 LFU/L of milk.

In an embodiment, composition may include a prebiotic material such as chicory root whole powder, leek whole plant powder, or pure inulin powder, which may be present in 0.025 to 1.0 g/L or 0.0625 g/L.

In an embodiment, the composition may include probiotic cultures of 300,000,000 colony forming units (CFU)/g of a blend of Bifidobacterium lactis, Bifidobacterium longum, Enterococcus faecium, Lactobacillus plantarum, Lactobacillus reuteri, Streptococcus thermophilus present in 0.005 to 0.25 g/L or 0.050 g/L of milk present in the composition. In an embodiment, the composition may include probiotic cultures of 100,000,000 CFU/g spores of Bacillus subtilis present in 0.001 to 0.25 g/L, or 0.0025 g/L of milk present in the composition. In an embodiment, the composition may include probiotic cultures of 15,000,000,000 CFU/g spores of Bacillus coagulans present in 0.00025 to 0.25 g/L of milk present in the composition.

In an embodiment, this invention provides a liquid nutritional composition for humans, having 1.0 L of fresh whole milk and 40.625 IMCU of chymosin. In an embodiment, the liquid nutritional composition for humans has 1.0 L of fresh whole milk; 40.625 IMCU of chymosin; 3125 U of lactase; 0.0625 g chicory root whole powder; 3.5 LFU of lingual lipase; 0.05 g of a mixture of Bifidobacterium lactis, Bifidobacterium longum, Enterococcus faecium, Lactobacillus plantarum, Lactobacillus reuteri, Streptococcus thermophilus having 300,000,000 CFU/g; 0.01 g of Bacillus subtilis spores having 100,000,000 CFU/g; and 0.01 g of Bacillus coagulans having 15,000,000,000 CFU/g.

In an embodiment, the composition is intended for consumption by adults or older children.

### DETAILED DESCRIPTION

The present invention provides a nutritional composition for older children and adults based on fresh milk. The problem with fresh milk products as a food for adults is that many adults are unable to digest fresh milk, because enzymes required to digest milk often fade following infancy and childhood. With the compositions discussed here, it is expected that many older children (over 5 years of age) and adults who are intolerant to fresh milk can consume this product safely without adverse effects and enjoy the nutritional benefits therefrom. The persons consuming this composition may be adults, over age 12 years, or older children, over age 5 years. The composition may include one or more added flavors, such as fruit flavors (banana, strawberry, blueberry, or apple) or flavors such as chocolate or vanilla. By making milk digestible to persons who cannot normally digest milk, the inventive compositions can be a source of protein and saturated fats which are important macronutrients.

Bovine milk is a rich source of protein that occurs primarily as casein (80%) and whey protein (20%). Casein in fresh milk is micellar, and adults often lose the ability to break up the micelles and digest the casein. This invention solves this problem by the addition of chymosin to a formulation of fresh milk as a nutritional beverage. The milk in this invention may be A1 or A2 milk. Unless otherwise specified herein, the term “milk” refers to bovine milk that is commonly available to consumers worldwide. However, milk from other species that is normally consumed by people, such as goat milk and sheep milk is within the scope of this invention.

Various other ingredients may also be included in the inventive beverage, including pregastric esterase or lingual lipase which specifically digest milk fat in the mouth and stomach, lactase which cleaves the glucose and galactose subunits of lactose, and prebiotics and probiotics.

In an embodiment, this invention provides a liquid nutritional composition comprising fresh whole milk and chymosin and one or more of the other ingredients selected from lactase, lipases or esterases, prebiotics, and probiotics. The whole milk of this invention may be raw, pasteurized, A1 milk, or A2 milk. This composition may be used as a food for animals or humans for long term or short-term use.

The term “about” as used herein means ±20 of the stated value.

As used herein, the term “adult” generally refers to humans over age 12, but the inventive compositions may also be beneficial to older children and children over the age of 5 years.

### Chymosin and Other Proteases

Chymosin (rennin) is naturally occurring in several species, in particular bovine stomachs, and it is also industrially produced for use in the manufacture of cheese by fermentation methods. Chymosin's primarily role is to aid in the digestion of casein in milk in animals that naturally make this protein.

Casein is the primary protein in bovine milk. Approximately 80% of the proteins in bovine milk and between 20% and 45% of the proteins in human milk are casein. Casein is relatively hydrophobic, making it weakly soluble in water. It occurs natively in milk as a suspension of particles, called casein micelles (also termed herein “micellar casein”), which show a limited resemblance to surfactant-type micelles in the sense that the hydrophilic parts reside at the surface of the micelles and casein micelles are spherical. However, in contrast to surfactant micelles, the interior of a casein micelle is highly hydrated. The caseins in the micelles are held together by calcium ions and hydrophobic interactions. Casein micelles form because there are four major types of casein molecules: alpha-s1, alpha-s2, beta and kappa. The alpha and beta caseins are hydrophobic proteins that are readily precipitated by calcium. However, kappa casein is not calcium-precipitable. The caseins self-associate into aggregates called micelles in which the alpha and beta caseins are kept from precipitating by their interactions with kappa casein. In essence, kappa casein normally keeps the majority of milk protein soluble and prevents it from spontaneously coagulating. Casein in micellar form is a principal component of milk protein concentrate (MPC), which is commercially available and used as an additive in many food products.

During digestion, casein becomes insoluble from the action of chymosin, which is specific for kappa casein. Chymosin proteolytically cuts and inactivates kappa casein, converting it into para-kappa-casein. Para-kappa-casein does not have the ability to stabilize the micellar structure allowing the modified micelle to have both negative and positive charges. This causes the calcium-insoluble to caseins precipitate, forming a curd. This is also termed “coagulation” of milk. The micelles rotate allowing positive charged regions to attach to negative charged regions of the modified micelles and a gel is formed in the stomach. Other proteases then decompose the gel. If milk is not coagulated during digestion, it would rapidly flow through the stomach and miss the opportunity for initial digestion of its proteins.

Humans do not naturally produce chymosin, but rather rely on other enzymatic mechanisms to digest milk as infants.²¹ The ability to digest casein may decrease with age. In order to address this problem, this invention provides chymosin added to whole milk. The whole milk of this invention may be raw, pasteurized, A1 milk, or A2 milk, or goat or sheep milk. The amount of chymosin may be about 5 International Milk Clotting Units (IMCU) to 200 IMCU per liter of whole milk. In an embodiment, about 40.625 IMCU/L is used. Chymosin is available commercially as a solution with 650 IMCU per mL.²² A preferred quantity of this chymosin solution may be 0.25 mL in 4 L of milk (0.0625 mL in 1 L milk). This is equivalent to about 162.5 IMCU in 4 L, or about 40.625 IMCU/L. In an embodiment about 0.010 mL to 0.10 mL of CHY-MAX® is used per liter of milk.

The term “IMCU” means International Milk Clotting Units. One IMCU equals about 0.126 nmol of bovine chymosin B (e.g., “CHY-MAX®” from Dairy Connection, Inc. in Madison, Wisconsin (US)²²). The strength of a milk clotting enzyme (such as chymosin enzyme present in a composition of the present invention) is determined as the milk clotting activity (IMCU per ml or per gram). IMCU is measured as the time needed for visible flocculation of renneted standard milk substrate with 0.05% calcium chloride at pH 6.5. IMCU/ml of a sample is determined by comparison of the clotting time to that of a standard having known milk clotting activity and having the same enzyme composition of the sample. The reference standard is given in ISO 11815:2007. For the first batch of both the calf and the adult bovine rennet reference standard powder, the activity was defined at 1,000 IMCU/g. Following the addition of diluted coagulant to a standard milk substrate, the milk will flocculate. The milk clotting time is the time period from addition of the coagulant until formation of visible flocks or flakes in the milk substrate. The strength of a coagulant sample is found by comparing the milk clotting time for the sample to that of a reference standard.

Chymosin is not active at low temperatures used for storage of milk. The coagulation from chymosin is most active in the range of 25° C. to 50° C.²³ Accordingly, chymosin can be blended with milk and the composition is expected to be shelf stable at milk storage temperatures. The chymosin will not exert its coagulant activity until ingested by a person. Chymosin activity is also promoted by the low pH in the gut. Chymosin, which is not natural to humans, has no adverse effects when ingested by humans, and in fact is commonly ingested in cheese products which employ chymosin during the manufacture of cheeses.

The chymosin in this invention may be obtained from Aspergillus niger, Kluyveromyces lactis (a yeast) and Escherichia coli.

Other proteases may also be of value in this invention, particularly chymotrypsin and trypsin, which are not necessarily specific for casein or whey, but do participate in the digestion of proteins in the stomach and intestine.

### Lactase

Lactose intolerance is very common in the adult population. Lactose is a disaccharide in milk having a glucose and galactose subunit. In infants, a β-D-galactosidase is secreted in the intestinal villi that cleaves the galactose-β-glucose linkage into glucose and galactose, which can be readily absorbed. In many adults this intrinsic enzyme is lost. Many of the undesirable health effects attributed to fresh milk are a direct result of lactose intolerance, such as gas, abdominal pain, and diarrhea. Artificial lactase has been available for many years to solve this problem. The present invention may include a lactase additive, for example “GODO-YNL” available from the Dairy Connection, Inc., Madison, Wisconsin. This product has an activity of 50,000 U/g. This invention may employ 0.01 to 2.0 g of this lactase product per 4 L of fresh milk. In an embodiment, 0.25 g to 0.50 g of this lactase product may be used, equivalent to about 12,500 to 25,000 U. This invention may employ lactase produced by fermentation of Kluyveromyces lactis (a yeast) or Bacillus licheniformis, a gram-positive, mesophilic bacterium.

Also, some embodiments of this invention may include Streptococcus thermophilus (see discussion under Probiotics) that also has activity of cleaving lactose.

Lactase activity is measured in U/g. One unit (U) of disaccharidase activity is calculated as the quantity of enzyme that will hydrolyze 1.0 μmol disaccharide substrate per minute at 37° C.²⁴

### Lipases and Esterases

This invention may also include one or more lipases specifically designed to break down fats in milk.

Lingual lipase and pregastric esterase are related lipases produced in the mouth of infant animals. In cattle, it is known that lingual lipase decreases with age. Presumably, this occurs in humans too. Accordingly, in an embodiment, the inventive formulation contains lingual lipase or the closely related pregastric esterase, in an amount ranging from provides 0.01 g to 1 g of enzyme in 4 L of milk. A preferred amount may be 0.25 g in 4 L of milk.

The present inventors postulate that a lack of essential preduodenal lipases, such as pregastric esterases or lipases (PGE's) may deprive a person with correct nutrition when consuming milk and milk products.²⁵ In the absence of PGE, there may be insufficient lipase activity further down the digestive tract to break down the triglyceride fats in butterfat in milk. This same principle may apply in other fat maldigestion conditions not involving neonates or infants, such as cystic fibrosis, pancreatic lipase insufficiency, non-alcoholic fatty liver, alcoholic fatty liver or post-surgical conditions. In these situations, lipases may be useful as a component of a nutritional supplement to aid in fat digestion. Cystic fibrosis patients often have pancreatic insufficiency and fail to produce sufficient pancreatic lipase which can cause fat maldigestion.

Fat maldigestion may result in malabsorption of nutrients. This problem may be addressed in the inventive formulations by the addition of nutrients, both macro and micro nutrients, in various forms and bioactive nutrient components, For example, a macro nutrient may be micellar casein or isolated soy protein or omega 3 fatty acids or a carbohydrate such as lactose or glucose, or a digestive aid including enzymes. For example, bioactive nutrition components may be caffeine, isoflavones, growth factors, anti-inflammatory components or anti-oxidant plant pigments.

Lingual lipase is a member of a family of digestive enzymes called triacylglycerol lipases, EC 3.1.1.3, that use the catalytic triad of aspartate, histidine, and serine to hydrolyze medium and long-chain triglycerides into partial glycerides and free fatty acids. The enzyme, released into the mouth along with the saliva, catalyzes the first reaction in the digestion of dietary lipid, with diglycerides being the primary reaction product. Lingual lipase has pH optimum pH of 4.5-5.4, and catalyzes the hydrolysis of esters in the absence of bile salts. The lipolytic activity continues in the stomach after food is swallowed, and it has been proposed that fats generally may not digest properly in neonates in the absence of lingual lipase.²⁶ Enzyme release is signaled by autonomic nervous system after ingestion, at which time the serous glands under the circumvallate and foliate lingual papillae on the surface of the tongue secrete lingual lipase to the grooves of the circumvallate and foliate papillae.

Other lipases, such as pancreatic lipases, lipases present in milk, and lipases from plant or fungal/biosynthetic sources, typically require a co-factor for the lipase activity, in particular, bile salts. No co-factor is required for animal-derived PGE's, including lingual lipase.²⁷ This is a potentially important feature for the lipases of this invention.

Specific lipases that may be employed in this invention include lingual lipase and capalase L. Capalase L is commercially available from Nelson-Jameson, Inc., Marshfield WI (US).

Lipase activity is measured in lipase/esterase forestomach units (LFU). The lipase activity is determined by measuring the free butyric acid liberated from tri-n-butryin substrate using a pH-stat under standard conditions, i.e. pH 6.2 and 42° C. as described in Food Chemicals Codex, Third ed. 111/General Tests and Apparatus/493. One LFU is the activity that releases 1.25 μmol of butyric acid per minute under the conditions of the assay. Commercially available preparations of lipase for use in making cheese generally have about 30-70 LFU/g (Dairy Connection). In an embodiment, about 2-5 LFU of commercially available lipase is used in 1 L of milk, but a range of between 1 and 100 LFU per liter may be used. In an embodiment, about 3.5 LFU/L is used. This corresponds to about 0.0625 g of a commercial preparation having about 56 LFU/g.

The lipase for this invention may be obtained from mammalian sources. For example, lingual lipase used in cheese manufacture is obtained from tongues from calves, kids, lambs. Bovine and other mammalian lingual lipases are commercially available.

In an embodiment, the lipases or esterases for this invention may be mammalian enzymes produced synthetically, for example by inserted an appropriate DNA sequence encoding a mammalian lingual lipase or pregastric esterase into an expression system and cultivating the organism to produce the enzyme. Exemplary expression systems include bacteria such as E. coli and B. subtilis, and yeasts such as Saccharomyces. Many other expression systems are well known in the art for making heterologous peptides.²⁸ These synthetic mammalian lipases are within the scope of a “mammalian” lipase as used herein.

Ideally the lipase is a human or humanized lipase. The amino acid sequence of potential human and animal lingual lipase and pregastric esterases is known. 29 It is likely that lipases from other species will have activity in humans. Lipases from bacterial or plant sources are known but are less desirable.

### Prebiotics

Prebiotics stimulate the growth or activity of advantageous bacteria that colonize the large bowel by acting as substrate for favorable bacteria in the colon. 30 In an embodiment, a prebiotic may be a composition of inulin, fructo-oligosaccharides (FOS), galacto-oligosaccharides (GalOS), lactulose, or pectin. 31 This invention may include any of these materials. Sources of inulin include chicory root, Jerusalem Artichoke (a tuber vegetable native to North America), onions, and leeks. Inulin is available in refined form as a colorless, tasteless powder with no impact on sensory characteristics of food products. Alternatively, the vegetable products with high levels of inulin may be used as a dried powdered vegetable material, such as chicory root whole powder and leek whole plant powder. A commercially available form of fructo-oligosaccharides is BioSecure™ FOS available from Kindstrom-Schmoll Inc., Eden Prairie, MN.

Inulin is a polysaccharide composed mainly of fructose units (fructans), and typically has a terminal glucose. It consists of chain-terminating glucosyl moieties and a repetitive fructosyl moiety, which are linked by β(2,1) bonds. Because of the β(2,1) linkages, inulin is indigestible by the human enzymes ptyalin and amylase, which are adapted to digest starch. As a result, it passes unchanged through the upper digestive tract intact. Only in the colon do bacteria metabolize inulin contributing to its functional properties: reduced calorie value, dietary fiber, and prebiotic effects. After reaching the large intestine, inulin is converted by colonic bacteria to a prebiotic gel that is highly nourishing to gut microflora. A specific prebiotic useful in this invention is chicory root whole powder or leek whole plant powder. Chicory root powder contains about 68% inulin. 32 Pure inulin powder and pure fructo-oligosaccharides are also available and may be used in this invention.

In an embodiment, the composition of this invention may include 0.01 to 1.0 g chicory root whole powder per liter. In an embodiment, 0.025 to 0.10 g/L is used. In an embodiment 0.0625 g/L is used.

### Probiotics

Probiotics are beneficial digestive bacteria, which are an additional requirement for nutrition. Prebiotics can alter the composition of organisms in the gut microbiome. The addition of prebiotics and probiotics can populate the gut with appropriate bacteria that are required for digestion. Probiotic cultures are measured in colony forming units, or CFU's.

A number of specific probiotics may be used in this invention. In an embodiment, the invention may include a blend of non-spore forming cultures, including Bifidobacterium lactis, Bifidobacterium longum, Enterococcus faecium, Lactobacillus plantarum, Lactobacillus reuteri, Streptococcus thermophilus. This culture blend is commercially available, for example from Probi USA, Inc., Redmond, Washington. This blend has 300 million CFU/g. In an embodiment, 0.005 g to 0.25 g of this blend may be used per liter of milk. In an embodiment, 0.050 g of this blend is used.

In an embodiment, this invention may include Bacillus subtilis spores, commercially available as “OPTI-BIOME®” from Bio-Cat Microbials, Shakopee, Minnesota. This product has 100 billion CFU/g. In an embodiment, 0.001 g to 0.25 g of this product is used per liter. In an embodiment, 0.0010 to 0.010 g/L is used. In an embodiment, 0.0025 g/L is used.

In an embodiment, this invention may include Bacillus coagulans spore cultures, commercially available from UAS Labs, Wassau, Wisconsin, sold under the brand name ProDURA®. This product has 15 billion CFU/g. In an embodiment, 0.00025 g to 0.25 g is used per liter of milk. In an embodiment, 0.0010 to 0.010 g/L is used. In an embodiment, 0.0025 g/L is used.

### Compositions of the Invention

In an embodiment, this invention provides a liquid nutritional composition of fresh whole milk and a quantity of chymosin having about 5 International Milk Clotting Units (IMCU) to 200 IMCU per liter of milk. The chymosin quantity may be 40.625 IMCU/L of milk. The milk may be commercially available, from a bovine source, and may be any conventional milk such as fresh whole A1 or A2 milk. Alternatively, the milk can be sheep milk or goat milk, which is also available for human consumption.

In an embodiment, the composition is a free-flowing dry powdered composition containing a chymosin, wherein the dry free-flowing dry powdered composition is intended to be dissolved in bovine milk. In an embodiment, a dry free-flowing dry powdered composition may include chymosin, a lactase, a lipase, a prebiotic and a probiotic. Excipients may be added also to aid in the flow properties or to provide bulk to the free-flowing dry powdered composition, such as silica, dextrose, and dicalcium phosphate. The free-flowing dry powdered composition is added to milk and dispersed or suspended by stirring to obtain a milk-based liquid nutritional composition.

In an embodiment, the composition may further include an ingredient selected from lactase, a mammalian-derived lipase, a prebiotic, and a probiotic or a combination thereof. Lactase, if present, may be present in about 1000-20000 UIL of milk, may be present in about 3125 U/L of milk. A mammalian-derived lipase, if present, may be present in 1-100 lipase/esterase forestomach units per liter (LFU/L), or 2-5 LFU/L, or 3.5 LFU/L. A prebiotic, if present, may be chicory root whole powder, leek whole plant powder, or pure inulin powder present in 0.025 to 1.0 g/L or 0.0625 g/L.

A probiotic, if present, may include probiotic cultures of 300,000,000 colony forming units per gram (CFU/g) of a blend of Bifidobacterium lactis, Bifidobacterium longum, Enterococcus faecium, Lactobacillus plantarum, Lactobacillus reuteri, Streptococcus thermophilus present in 0.005 g/L to 0.25 g/L or 0.050 g/L. A probiotic may also include probiotic cultures of 15,000,000,000 CFU/g spores of Bacillus coagulans present in 0.00025 g·L to 0.25 g/L.

In addition, flavors may be added to the dry powdered composition, such as fruit flavors, chocolate, vanilla, cinnamon, hazelnut, and the like.

In an embodiment, a dry composition of this invention may contain the following ingredients:

| | Amount (g) unless |
|---|---|
| Ingredient | otherwise stated |
| Chymosin (CHY-MAX ®) | 0.019 to 0.58 |
| Lactase | 0.25 to 1.00 |
| Lingual Lipase | 0.40 to 1.50 |
| Capalase L | 0.050 to 0.15 |
| Chicory root powder (crude inulin) | 0.80 to 3.30 |
| fructo-oligosaccharides bioSecure ™ FOS | 0.30 to 1.25 |
| Probiotic Blend Probi | 0.025 to 0.075 |
| ProDURA ® | 0.0050 to 0.015 |
| OPTI-BIOME ® MB40 | 0.0050 to 0.015 |
| Sorbitol | 0.25 to 1.00 |
| Dextrose | 0.25 to 1.00 |
| Silica | 0.006 to 0.025 |
| Calcium Carbonate | 0.040 to 0.16 |
| Dicalcium phosphate | 25 to 75 μg |

The above composition is intended for suspension into 0.5 L of fresh milk for human consumption. The powder is added to cold fresh milk and stirred to obtain and uniform suspension or dispersion. The total weight of this dry powdered blend may be 5 g. This blend may be provided in single use packets containing 5 g or packaged in larger sizes (for example 100 g or 250 g containers) with a 5 g scoop.

### Preparation of the Liquid Composition

The inventive composition is prepared by blending chymosin with whole milk, and optionally adding one or more of the other ingredients discussed above, selected from lactase, lipases or esterases, prebiotics, and probiotics. The whole milk of this invention may be raw, pasteurized, A1 milk, A2 milk, goat milk, or sheep milk. The mixture is stirred until it is a uniform suspension of the chymosin and other ingredients.

The chymosin blended with milk will not affect the milk until the milk is consumed. Chymosin is not active at coagulating milk at low temperatures used for the storage of milk (4° C./39° F.), so the inventive composition is expected to be shelf stable.

The nutritional composition may be provided as a beverage. Additional flavoring agents may be added, such as chocolate flavor, vanilla flavor, or fruit flavors, such as banana, apple, blueberry, strawberry, and the like.

### EXAMPLES

### Example 1

An exemplary formulation for a beverage according to this invention is:

| | | | Source |
|---|---|---|---|
| 1.0 | L | Raw or Pasteurized Whole Milk | |
| 40.625 | IMCU | chymosin | “CHY-MAX ® EXTRA (DCI Star)” |
| | | | from Dairy Connection, Inc. in |
| | | | Madison WI |
| 3125 | U | Lactase | “GODO-YNL” available from the |
| | | | Dairy Connection, Inc., Madison, WI |
| 0.0625 | g | Chicory Root Whole Powder (prebiotic) | Various sources |
| 3.5 | LFU | Pregastric esterase or lingual lipase | Commercially available from Dairy |
| | | | Connection, Inc., Madison, WI |
| 0.05 | g | Probiotic Cultures - Non Spore Forming. | Probi USA, Inc., Redmond, |
| | | Bifidobacterium lactis, Bifidobacterium longum, | Washington |
| | | Enterococcus faecium, Lactobacillus plantarum, | |
| | | Lactobacillus reuteri, Streptococcus thermophilus, | |
| | | 300,000,000 CFU/g | |
| 0.01 | g | Probiotic Cultures - Spore Forming | “OPTI-BIOME ®” from Bio-Cat |
| | | B. subtilis, 100,000,000 CFU/g | Microbials, Shakopee, Minnesota |
| 0.01 | g | Probiotic Cultures - Spore Forming | UAS Labs, Wassau, Wisconsin |
| | | B. coagulans, 15,000,000,000 CFU/g | |

The above ingredients are blended to provide a nutritional beverage. The beverage is stable in refrigeration as long as the milk stays fresh. This is a novel nutritional composition based on dairy that will be acceptable to many adults who are normally dairy intolerant.

### Example 2

An exemplary free-flowing dry powder blend is:

| Material | Wt in g |
|---|---|
| Lingual lipase | 0.880000 |
| Chicory root powder (crude inulin) | 1.683450 |
| Dextrose | 0.525000 |
| Sorbitol | 0.500000 |
| fructo-oligosaccharides bioSecure ™ FOS | 0.611000 |
| Silica | 0.012000 |
| Calcium Carbonate | 0.080000 |
| Dicalcium phosphate | 0.000050 |
| Capalase L | 0.100000 |
| Chymosin (CHY-MAX ®) | 0.038500 |
| Lactase | 0.500000 |
| Probiotic Blend Probi | 0.050000 |
| ProDURA ® (probiotic) | 0.010000 |
| OPTI-BIOME ® MB40 (probiotic) | 0.010000 |
| Total | 5.000 |

The above ingredients are blended into a powdered mixture intended for use in 500 mL of milk for human consumption. The powdered mixture may be packaged in single use packets or in bulk containers containing for example, 100 g or 200 g and a 5 g scoop. The blend is added to milk and stirred to dissolve.

In addition to the above list, various flavors may be added for example fruit flavors or chocolate flavor to improve the palatability of the

### REFERENCES

¹ Scientific Report of EFSA prepared by a DATEX Working Group on the potential health impact of β-casomorphins and related peptides. EFSA Scientific Report (2009) 231, 1-107, DOI: 10.2903/j.efsa.2009.231r
² Sun Jianqin et al., Effects of milk containing only A2 beta casein versus milk containing both A1 and A2 beta casein proteins on gastrointestinal physiology, symptoms of discomfort, and cognitive behavior of people with self-reported intolerance to traditional cows' milk, Nutr J, 2016 Apr. 2; 15:35. doi: 10.11861s12937-016-0147-z.
³ William G Manson, Lawrence T Weaver, “Fat digestion in the neonate,” Arch. Dis. Childhood, 1997, 76, F206-F211; PMID: 9175955.
⁴ Margit Hamosh, A Review. Fat Digestion in the Newborn: Role of Lingual Lipase and Preduodenal Digestion, Pediatric Research, 13, 615-622 (1979), doi: 10.1203/00006450-197905000-00008
⁵ Id.
⁶ Mahmood Hussain, M “A proposed model for the assembly of chylomicrons,” Atherosclerosis, 148(1), 1-15 (2000), doi: 10.1016/S0021-9150(99)00397-4
⁷ Lipases in bovine milk: C. V. Patel et al., “Bovine Milk Lipase. II. Characterization” J. Dairy Sci. 1968, 51(12), 1879-1886 https://doi.org/10.3168/jds.S0022-0302(68)87306-0; lipases in human milk: William G Manson, Lawrence T Weaver, “Fat digestion in the neonate,” Arch. Dis. Childhood, 1997, 76, F206-F211; PMID: 9175955.
⁸ Nelson, J. H., et al., “Pregastric Esterase and other Oral Lipases—A Review,” J. Dairy Sci., 1977, 60(3) 327-362, doi: 10.3168/jds.50022-0302(77)83873-3
⁹ Manson 1997, n. 3.
¹⁰ Hamosh, M and Hamosh, P “Gastric Lipase: Characteristics and Biological Function of Preduodenal Digestive Lipases” in “Esterases, Lipases, and Phospholipases: From Structure to Clinical Significance Volume 266 of Nato Science Series A” Editors: M. I. Mackness, M. Clerc; Springer 1994, pp. 139-148. ISBN 1489909931, 9781489909930; Hernell, O; Blackberg L, “Molecular aspects of fat digestion in the newborn,” Acta Paediatr Suppl 1994, 405, 65-9; https://doi.org/10.1111/j.1651-2227.1994.tb13401.x; Roussel, Alain, et al., “Crystal Structure of Human Gastric Lipase and Model of Lysosomal Acid Lipase, Two Lipolytic Enzymes of Medical Interest,” J. Biol. Chem. 1999, 274(24), 16995-17002; https://doi.org/10.1074/jbc.274.24.16995
¹¹ Fojan, P. et al., “What distinguishes an esterase from a lipase: A novel structural approach,” Biochimie, 2000, 82 (11) 1033-1041, https://doi.org/10.1016/S0300-9084(00)01188-3
¹² Table 3 in Hamosh 1994, see also Manson 1997, n. 7
¹³ Sweet, B. J., et al. “Purification and characterization of pregastric esterase from calf,” Arch Biochem Biophys. 1984, 234, 144-150, https://doi.org/10.1016/0003-9861(84)90335-7; see also Manson 1997, n. 7
¹⁴ Table 3 in Hamosh 1994, n. 10
¹⁵ Id.
¹⁶ Smith, L. J., Kaminsky, S. and D'souza, S. W. “Neonatal Fat Digestion and Lingual Lipase,” Acta Pxdiatrica, 1986, 75 913-918. doi: 10.1111/j.1651-2227.1986.tb10316.x
¹⁷ M. Lucarini, “Bioactive peptides in milk: from encrypted sequences to nutraceutical aspects,” Beverages 2017, 3, 41; doi:10.3390/beverages3030041
¹⁸ Kumar, A.; Grover, S.; Sharma, J.; Batish, V. K.; “Chymosin and other milk coagulants: sources and biotechnological interventions,” Crit. Rev. Biotechnol. 30, 243-258 (2010), DOI: 10.3109/07388551.2010.483459
¹⁹ Demers-Mathieu, Veronique, et al “Premature Infants have Lower Gastric Digestion Capacity for Human Milk Proteins than Term Infants,” J. Ped. Gastroenterology and Nutrition, 2018 66(5) 816-821 doi: 10.1097/MPG.0000000000001835
²⁰ http://blog.cheesemaking.com/about-lipase/ (downloaded Jul. 3, 2018)
²¹ See Demers-Mathieu, n. 19
²² For example, “CHY-MAX® EXTRA (DCI Star)” from Dairy Connection, Inc. in Madison WI, https://www.dairyconnection.com/CHY-MAX-EXTRA-STAR.html. CHY-MAX® EXTRA has 650 IMCU per mL.
23 Jose Alberto Espinoza-Molina et al., “Codon Optimization of the Bos Taurus Chymosin Gene for the Production of Recombinant Chymosin in Pichia pastoris” Mol Biotechnol. 2016 October; 58(10):657-664. doi: 10.1007/s12033-016-9965-7. See also BRENDA reference 754695.
²⁴ Hackenmueller S. A., Grenache D. G. Reference Intervals for Intestinal Disaccharidase Activities Determined from a Non-Reference Population. J. Appl. Lab. Med., 2016 doi: 10.1373/jalm.2016.020388.
²⁵ See WO 2020/023521 A1 for a further discussion of this problem.
²⁶ Note 4.
²⁷ Note 1 at 143, bottom.
²⁸ See, e.g., Joan Lin Cereghino James M. Cregg, “Heterologous protein expression in the methylotrophic yeast Pichia pastoris,” FEMS Microbiology Reviews, Volume 24, Issue 1, 1 Jan. 2000, Pages 45-66, https://doi.org/10.1111/j.1574-6976.2000.tb00532.x
²⁹ See for example “Cloning and expression of cDNA encoding human lysosomal acid lipase/cholesteryl ester hydrolase. Similarities to gastric and lingual lipases” J. Biol. Chem. 266 (33), 22479-22484 (1991). The sequence of bovine pregastric esterase is also known: Timmermans, M. Y., Teuchy, H. and Kupers, L. P., The cDNA sequence encoding bovine pregastric esterase, Gene 147 (2), 259-262 (1994); NCBI NP_776528.
³⁰ Hutkins, R. W. et al., “Prebiotics: why definitions matter” Curr Opin Biotechnol. 2016 February, 37:1-7. doi: 10.1016/j.copbio.2015.09.001. Epub 2015 Sep. 29.
³¹ Belén Gómez, et al., “Purification, Characterization, and Prebiotic Properties of Pectic Oligosaccharides from Orange Peel Wastes,” J. Ag. Food Chem., 2014 62 (40), 9769-9782 DOI: 10.1021/jf503475b
³² Ifeoma Chinyelu Nwafor, Karabo Shale, Matthew Chilaka Achilonu, “Chemical Composition and Nutritive Benefits of Chicory (Cichorium intybus) as an Ideal Complementary and/or Alternative Livestock Feed Supplement”, The Scientific World Journal, vol. 2017, Article ID 7343928, 11 pages, 2017. https://doi.org/10.1155/2017/7343928

1. A liquid nutritional composition comprising fresh whole milk and a quantity of chymosin having about 5 International Milk Clotting Units (IMCU) to 200 IMCU per liter of milk.

2. The liquid nutritional composition of claim 1, wherein the chymosin quantity is 40.625 IMCU/L of milk.

3. The liquid nutritional composition of claim 1, in which the fresh whole milk is A1 or A2 milk.

4. The composition of claim 1, further comprising an ingredient selected from lactase, a mammalian-derived lipase, a prebiotic, and a probiotic or a combination thereof.

5. The composition of claim 4, wherein an ingredient is lactase, and wherein the lactase is present in about 1000-20000 U/L of milk.

6. The composition of claim 5, wherein the lactase is present in about 3125 U/L of milk.

7. The composition of claim 4, wherein an ingredient is a mammalian-derived lipase, and the lipase is lingual lipase or pregastric esterase.

8. The composition of claim 7, wherein the lipase is present in a quantity of 1-100 lipase/esterase forestomach units per liter (LFU/L), or 2-5 LFU/L, or 3.5 LFU/L.

9. The composition of claim 4, wherein an ingredient is a prebiotic, wherein the prebiotic comprises chicory root whole powder, leek whole plant powder, or pure inulin powder present in 0.025 g/L to 1.0 g/L or 0.0625 g/L.

10. The liquid nutritional composition of claim 1, further comprising probiotic cultures of 300,000,000 colony forming units per gram (CFU/g) of a blend of Bifidobacterium lactis, Bifidobacterium longum, Enterococcus faecium, Lactobacillus plantarum, Lactobacillus reuteri, Streptococcus thermophilus present in 0.005 to 0.25 g/L or 0.050 g/L.

11. The liquid nutritional composition of claim 1, further comprising probiotic cultures of 100,000,000 CFU/g spores of Bacillus subtilis present in 0.001 to 0.25 g/L, or 0.0025 g/L.

12. The liquid nutritional composition of claim 1, further comprising probiotic cultures of 15,000,000,000 CFU/g spores of Bacillus coagulans present in 0.00025 to 0.25 g/L.

13. The liquid nutritional composition of claim 1, wherein the composition is consumed by a person greater than 5 years of age.

14. The liquid nutritional composition of claim 1, wherein the composition is consumed by a person greater than 12 years of age.

15. A liquid nutritional composition for humans, comprising 1.0 L of fresh whole milk and 40.625 IMCU of chymosin.

16. A liquid nutritional composition for human consumption, comprising 1.0 L of fresh whole milk; 40.625 IMCU of chymosin; 3125 U of lactase; 0.0625 g chicory root whole powder; 3.5 LFU of lingual lipase; 0.05 g of a mixture of Bifidobacterium lactis, Bifidobacterium longum, Enterococcus faecium, Lactobacillus plantarum, Lactobacillus reuteri, Streptococcus thermophilus having 300,000,000 CFU/g; 0.01 g of Bacillus subtilis spores having 100,000,000 CFU/g; and 0.01 g of Bacillus coagulans having 15,000,000,000 CFU/g.

17. A free-flowing dry powdered composition comprising a chymosin, a lactase, a lipase, a prebiotic and one or more probiotic cultures, wherein the composition is intended to be dissolved in milk for human consumption.

18. The composition of claim 17 further comprising excipients selected from dextrose, sorbitol, silica, calcium carbonate, and dicalcium phosphate, or a combination thereof.

19. The composition of claim 17 further comprising flavoring agents.

20. The composition of claim 17, wherein the milk is bovine milk, sheep milk, or goat milk.

21. A free-flowing dry powdered composition comprising 5 g of a blend of about 0.019 to 0.58 g of chymosin, 0.25 to 1.00 g lactase, 0.40 to 1.50 g of one or more lipases, 1.10 to 4.55 g of one or more forms of prebiotics selected from inulin and fructo-oligosaccharides or both, and 0.035 to 0.105 g of one or more probiotic cultures, wherein the dry powdered free-flowing composition is intended for dissolution in milk for human consumption.

22. A method of preparing a milk-based composition for human consumption comprising adding a free-flowing dry powder composition comprising 5 g of a blend of about 0.019 to 0.58 g of chymosin, 0.25 to 1.00 g lactase, 0.40 to 1.50 g of one or more lipases, 1.10 to 4.55 g of one or more forms of prebiotics selected from inulin and fructo-oligosaccharides or both, and 0.035 to 0.105 g of one or more probiotic cultures to 0.5 L of fresh cold milk and stirring the mixture until the powder composition is uniformly suspended in the milk.
